(19) United States
(12) Patent Application Publication
(10) Pub. No.: US 2026/0276400 A1
(43) Pub. Date: Sep. 17, 2026

(54) METHOD FOR DISPLAYING ALTERNATIVE NAVIGATION ROUTE, AND NAVIGATION DEVICE

(71) Applicant: Namseok KANG, Seoul (KR)

(72) Inventor: Namseok KANG, Seoul (KR)

(21) Appl. No.: 19/677,864

(22) Filed: May 14, 2026

Related U.S. Application Data
(63) Continuation of application No. 18/707,658, filed on Nov. 4, 2022.

(30) Foreign Application Priority Data
Nov. 8, 2021 (KR) 10-2021-0151965

(51) Int. Cl. G01C 21/36

(52) U.S. Cl. CPC G01C 21/3676

(57) ABSTRACT

A navigation device according to an embodiment may comprise: a user interface receiving an input from a user and displaying a route; and a control unit configured to control the user interface to display a route to a destination entered by the user as an existing route, and, when receiving, from the user, an avoidance trigger input corresponding to a guided action on a road traveled by a vehicle, determine at least one alternative route including at least one alternative action different from the guided action, and control the user interface to display the at least one alternative route.

### CROSS REFERENCE TO RELATED APPLICATIONS

This application is a Continuation-in-Part of U.S. application Ser. No. 18/707,658 filed May 6, 2024, which is a National Stage of International Application No. PCT/KR2022/017281 filed Nov. 4, 2022, claiming priority based on Korean Patent Application No. 10-2021-0151965 filed Nov. 8, 2021, of which entire contents are incorporated by reference in their entireties.

### TECHNICAL FIELD

The present invention relates to a method and device for displaying alternative navigation routes, and, more specifically, to a technology for a navigation device and a control method that displays various alternative routes to a destination based on the current location, tailored to user preferences.

### BACKGROUND ART

Navigation devices display the current position of a moving body, such as a vehicle, on a map using GPS signals received from the Global Positioning System. These navigation devices are widely used in various moving bodies, including ships, aircraft, and vehicles, to check the current position and moving speed of the body or to determine a travel route.

Generally, navigation devices used in vehicles, upon the user entering a destination, use map information to search for a driving route to the destination and guide the vehicle along the selected driving route. Additionally, the navigation device provides various information visually or audibly, such as the driving route to the destination, nearby geographical features, and road congestion levels, thereby providing a guide to help the user reach the destination.

Recently, navigation devices have begun to suggest alternative routes that can replace the existing route to the destination, and they are capable of displaying comparative data between the existing route and the alternative routes.

However, often the alternative routes are not the routes desired by the user, leading to a low frequency of using these alternative routes, and failing to provide a real alternative to the user. Additionally, conventional alternative route suggestions are often limited to a manner in which a navigation device provides an alternative route determined by itself, and there is a limitation in providing an alternative action or an alternative route that reflects an explicit avoidance intention of a user not to follow a specific driving maneuver (or driving action) currently being guided.

### DISCLOSURE

### Technical Problem

Therefore, the method and device for displaying alternative navigation routes according to an embodiment are inventions designed to solve the aforementioned problems, with the objective of providing a navigation device that appropriately displays alternative routes tailored to user preferences based on user input.

More specifically, the navigation device and control method according to an embodiment, during the process of navigating to a destination, propose at least one alternative route that does not follow a junction selected by the user but another junction, when there is user input, thus providing a navigation device and control method that can expand the user's choice of routes.

Additionally, a navigation device and a method of controlling the navigation device according to an embodiment may provide an alternative action or an alternative route corresponding to an avoidance intention when a user inputs the avoidance intention for a specific driving maneuver currently being guided.

### Technical Solution

In order to achieve the above objects, the present invention provides a navigation device comprising a user interface receiving an input from a user and displaying a route; and a control unit configured to control the user interface to display a route to a destination entered by the user as an existing route, and, when receiving, from the user, an avoidance trigger input corresponding to a guided action on a road traveled by a vehicle, determine at least one alternative route including at least one alternative action different from the guided action, and control the user interface to display the at least one alternative route.

The control unit may control the user interface to display comparison information between each alternative route among the at least one alternative route and the existing route.

The comparison information may include at least one of information on the increase or decrease in distance compared to the existing route, information on the increase or decrease in time compared to the existing route, and information on the increase or decrease in cost compared to the existing route.

The avoidance trigger input may include at least one of an input through the user interface, a voice-based input, and a predefined trigger input, wherein the control unit may determine the at least one alternative route based on a past avoidance history of the user when the avoidance trigger input is received, and wherein, for an alternative route among the at least one alternative route, the control unit may obtain at least one of a first history of another vehicle that selected the existing route without selecting the alternative route or an expected history at a time when the existing route is proposed, obtain a second history of a vehicle that selected the alternative route, display a difference between the second history and at least one of the first history or the expected history through the user interface, and reflect the difference in a subsequent route recommendation.

The control unit may control the user interface to display an alternative route selected by the user when the user selects one alternative route from among the at least one alternative route.

The control unit may replace the existing route with an alternative route selected by the user when the user selects one alternative route from among the at least one alternative route.

The method for displaying alternative navigation routes according to an embodiment may include: controlling the user interface to display a route to a destination entered by a user as an existing route; receiving, from the user, an avoidance trigger input corresponding to a guided action on a road traveled by a vehicle; determining, in response to receiving the avoidance trigger input, at least one alternative route including at least one alternative action different from the guided action; and controlling the user interface to display the at least one alternative route.

### Advantageous Effects

According to the navigation device and method for displaying alternative navigation routes of an embodiment of the present invention, multiple alternative routes that use different junctions from the one selected by user input can be provided. This allows users to choose alternative routes that better suit their preferences, thereby expanding the range of alternative route choices. Additionally, the navigation provider can enhance the route navigation algorithm based on data from users' choices of alternative routes.

Additionally, when a user inputs an avoidance intention for a driving maneuver currently being guided, the navigation device according to an embodiment may determine at least one alternative action different from the driving maneuver or at least one alternative route corresponding to the alternative action.

### BRIEF DESCRIPTION OF DRAWINGS

FIG. 1 is a block diagram showing some components of a navigation device according to an embodiment of the present invention.

FIG. 2 illustrates a navigation device according to an embodiment displaying a route to a destination.

FIG. 3 illustrates a navigation device according to an embodiment displaying a list of alternative routes in response to user input.

FIG. 4 illustrates a navigation device according to an embodiment displaying an alternative route in response to user input.

FIG. 5 illustrates a navigation device according to an embodiment replacing a route with an alternative route in response to user input.

FIG. 6 is a flowchart showing the process of determining an alternative route that uses a junction other than the one selected by the user, according to an embodiment of the navigation device's control method.

FIG. 7 is a diagram illustrating a case in which a navigation device according to an embodiment determines and displays at least one alternative action different from a guided driving action at the same junction as a guided junction, in response to an avoidance trigger input of a user.

FIG. 8 is a diagram illustrating a case in which a navigation device according to an embodiment determines and displays at least one alternative action.

### BEST MODE

The embodiments and configurations depicted in the drawings of the specification are merely exemplary embodiments of the present invention, and various modifications capable of substituting the embodiments and drawings described herein may exist at the time of the present application.

Throughout this specification, when one part is said to be “connected” to another, this includes not only direct connections but also indirect connections, which encompass connections made through wireless networks.

Furthermore, the terminology used in this specification is intended for describing particular embodiments only and not intended to limit the present invention. Unless contextually indicated otherwise, singular expressions include plural expressions. In this specification, terms like “comprise” or “have” indicate the presence of stated features, numbers, steps, operations, components, parts, or combinations thereof, and do not preclude the presence or addition of one or more other features, numbers, steps, operations, components, parts, or their combinations.

Additionally, terms that include ordinal numbers such as “first” and “second” are used to describe various components, but these components are not limited by these terms. These terms are only used to distinguish one component from another. For instance, without departing from the scope of the present invention, a first component may be designated as a second component, and similarly, a second component may also be designated as a first component.

Moreover, terms such as “unit,” “device,” “block,” “member,” “module,” etc., may refer to a unit that processes at least one function or operation. For example, these terms could denote at least one hardware like FPGA (field-programmable gate array)/ASIC (application specific integrated circuit), at least one software stored in memory, or at least one process handled by a processor.

The reference numerals assigned to each step are used for identifying the steps and do not indicate the sequence of the steps; the steps can be performed in an order different from the one described unless explicitly stated otherwise in the context.

Subsequently, detailed descriptions of embodiments regarding the navigation device and its control method according to one aspect will be provided with reference to the accompanying drawings.

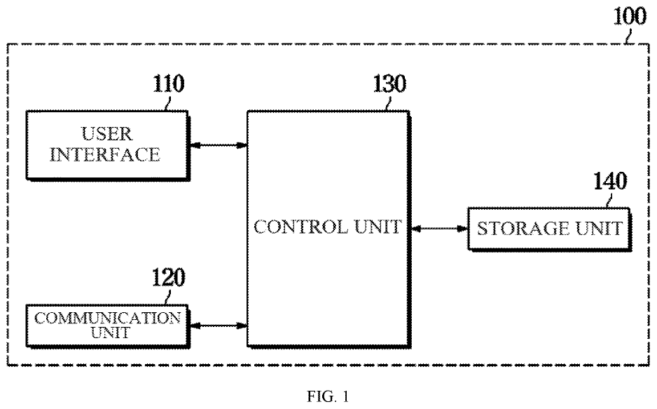

FIG. 1 is a block diagram showing some components of a navigation device according to an embodiment of the present invention.

Referring to FIG. 1, a navigation device 100 according to an embodiment may include a user interface 110 that receives user input and displays routes, a communication unit 120 that receives communication signals (for example, GPS signals), a control unit 130 that determines alternative routes based on user input, and a storage unit 140 that stores various information needed for control.

The user interface 110 according to an embodiment may include an input device capable of receiving user inputs and a display panel capable of showing routes to a destination.

In this case, the input device may be a touch panel integrated with the display panel, according to an embodiment. However, this is not limited, and the input device can be provided as any type of device known in the art.

Furthermore, the display panel can be provided as a type known in the art and can display various information under the control of the control unit 130.

The communication unit 120 according to an embodiment can receive communication signals (for example, GPS signals) from an external device (for example, a satellite), and can be equipped with a communication module known in the art for this purpose.

The control unit 130 according to an embodiment can navigate and determine the route to the destination based on user input entered through the user interface 110 and can control the user interface 110 to display the determined route externally.

At this time, the control unit 130 can determine the current location of the navigation device 100 based on the communication signals received through the communication unit 120, and can determine the route from the current location to the destination based on the navigation settings information stored in the storage unit 140.

Additionally, the control unit 130 can control the user interface 110 to display junctions located on the route to the destination. Here, a junction refers to a point where a branching road diverges from the driving road, and the vehicle can exit the currently traveled road through the junction and enter the branching road. In essence, the junction can act as an exit on the driving road.

The control unit 130, upon receiving a user selection of a junction located on the route to the destination, can determine at least one alternative route that uses a different junction from the multiple junctions on the road where the navigation device 100 is installed and the vehicle is traveling.

In this case, the at least one alternative route may include a first alternative route that uses a junction located before the selected junction on the road where the vehicle is traveling, and a second alternative route that uses a junction located after the selected junction on the road where the vehicle is traveling.

The control unit 130 can control the user interface 110 to display information generated by comparing each of the at least one alternative route with the existing route.

At this time, the comparison information with the existing route may include at least one of the following: information on the increase or decrease in distance compared to the existing route, information on the increase or decrease in time compared to the existing route, or information on the increase or decrease in cost compared to the existing route.

The control unit 130 can control the user interface 110 to display the selected alternative route when a user selects any one of the at least one alternative route.

Additionally, the control unit 130 can replace the existing route with the selected alternative route when a user selects any one of the alternative routes.

The control unit 130 can determine at least one alternative route based on at least one of the following: the shortest distance, the lowest cost, the user's selection history, or the number of selections by other users.

Furthermore, the control unit 130 can determine at least one alternative route that satisfies at least one of the following set by the user: an increase or decrease in distance compared to the existing route, or an increase or decrease in time.

The control unit 130 may include at least one memory storing a program that performs the aforementioned actions and subsequent actions, and at least one processor that executes the stored program. When there are multiple memories and processors, they can be integrated into a single chip or located at physically separated locations.

The storage unit 140 may include well-known information necessary for performing navigation functions, such as map information and navigation settings. Additionally, the storage unit 140 can store the latest version information received from an external server through the communication unit 120, as well as usage records of other users.

Having described the various components of the navigation device 100, further details on how the navigation device 100 determines and displays alternative routes will now be explained.

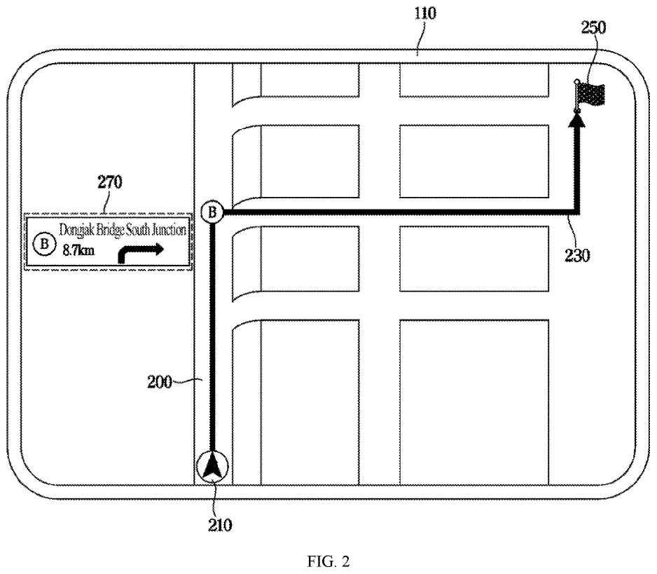

FIG. 2 illustrates an instance where the navigation device 100 displays the route to a destination and multiple junctions according to an embodiment.

Referring to FIG. 2, the navigation device 100 can control the user interface 110 to display the route 230 to a destination 250 and information 270 about junctions on the route 230 to the destination 250. However, according to an embodiment, the display of information 270 about junctions on the route 230 to the destination 250 may be omitted.

The route 230 displayed on the screen can be the route from the current location 210 of the navigation device 100 to the destination 250. For example, the route 230 to the destination 250, as shown in FIG. 2, may correspond to a route exiting via junction B from the driving road 200.

Furthermore, the information 270 about junctions on the route 230 to the destination 250, as illustrated in FIG. 2, may include information about a junction B located on the route to the destination 250, such as the remaining distance and the name of the junction.

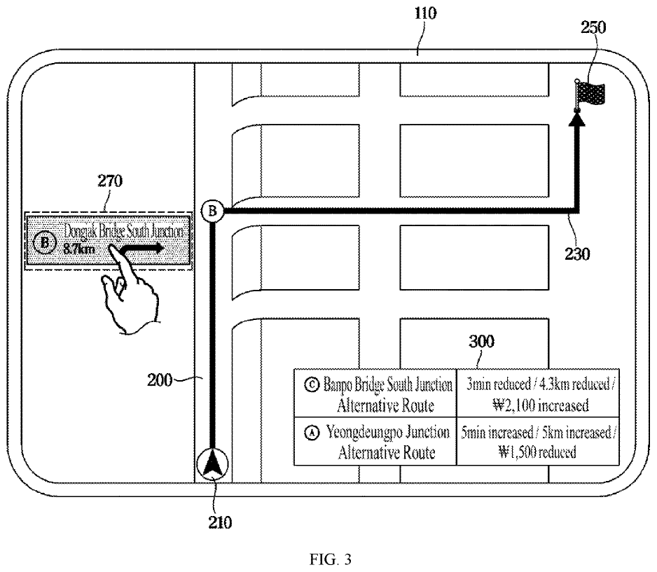

FIG. 3 is a diagram illustrating a case where the navigation device 100 displays a list of alternative routes based on user input according to an embodiment.

Referring to FIG. 3, the navigation device 100 can display alternative routes based on user input.

For example, the navigation device 100, as shown in FIG. 3, can display a list 300 of alternative routes.

Specifically, the navigation device 100 can determine at least one alternative route that uses a different junction (A, C) from the selected junction (B) among multiple junctions (A, B, C) on the driving road 200, when junction (B) on the route 230 to the destination 250 is selected. The navigation device can also control the user interface 110 to display the at least one alternative route.

The alternative routes may include several options, such as a first alternative route that uses a junction (A) located before the selected junction (B) on the driving road 200, and a second alternative route that uses a junction (C) located after the selected junction (B).

For example, if a user selects the Dongjak Bridge South Junction (B), the navigation device 100 can determine a first alternative route that uses the Yeongdeungpo Junction (A) located before the Dongjak Bridge South Junction (B) and a second alternative route that uses the Banpo Bridge South Junction (C) located after the Dongjak Bridge South Junction (B), as illustrated in FIG. 3.

At this time, the navigation device 100 can control the user interface 110 to display comparison information generated by comparing each of the multiple determined alternative routes with the existing route 230. The comparison information may include at least one of the following: information on the increase or decrease in distance, time, or cost compared to the existing route 230.

For instance, as shown in FIG. 3, the navigation device 100 can display comparison information for each alternative route on the list of alternative routes 300, comparing them with the existing route 230.

This allows users, who do not wish to follow the junction guided by the navigation device 100, to see the potential increases or decreases in distance, time, or cost when using different junctions, enabling them to choose the alternative route that best suits their needs. Thus, the navigation device 100, according to an embodiment of the invention, provides information on routes associated with various junctions (A, B, C) located on the driving road 200, allowing users to select alternative routes that suit their preferences and expand their range of route choices.

Additionally, when determining an alternative route that uses a different junction (A, C) from the selected junction (B), the navigation device 100 can determine the alternative route based on at least one of the following: the shortest distance, the lowest cost, the user's selection history, or the frequency of selections by other users.

For example, when determining an alternative route that uses junction (A), the navigation device 100 can decide on an alternative route that results in the shortest distance to the destination 250 while using junction (A), or it can choose an alternative route that minimizes the cost incurred to reach the destination 250 while using junction (A).

Additionally, the navigation device 100 can determine alternative routes based on various criteria. For example, it can choose an alternative route that includes roads used more than a preset number of times by the user with junction (A) as part of the route, or it can include in the route roads that other users have used more than a preset number of times based on usage history received from an external server, or apply trends of increased and decreased usage at the time of navigation to recommend roads to be included in the route.

Furthermore, the navigation device 100 can determine an alternative route that satisfies at least one of the conditions set by the user for an increase or decrease in distance or time compared to the existing route 230.

That is, users can set the range of alternative route choices through the user interface 110 and can set threshold values for increased or decreased distance, as well as for increased or decreased time required compared to the existing route.

In this case, the navigation device 100 can determine an alternative route that has an increase or decrease in distance less than the set threshold value relative to the existing route. Similarly, it can determine an alternative route that has an increase or decrease in time less than the threshold value relative to the existing route.

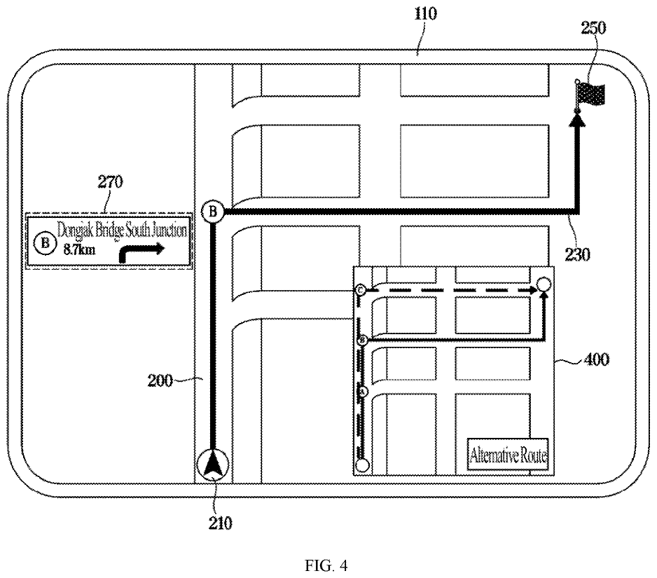

FIG. 4 illustrates a scenario where the navigation device 100 displays an alternative route based on user input according to an embodiment.

Referring to FIG. 4, the navigation device 100 can control the user interface 110 to display the selected alternative route when a user selects one from at least one alternative route during the navigation guidance process.

Users can choose any one of the alternative routes from the list 300, and as shown in FIG. 4, the navigation device 100 can display the screen guiding the alternative route 400 overlaid with the screen guiding the existing route 230. The screen guiding the alternative route 400 can be displayed on the user interface 110 using picture-in-picture (PIP) or navigation-in-picture (NIP) methods. That is, the screen 400 guiding the alternative route can be displayed as a mini-window on the screen guiding the existing route 230.

For example, if a user selects the alternative route that includes Banpo Bridge South Junction (C) as the route, the navigation device 100 can control the user interface 110 to display the screen 400 guiding the alternative route.

This allows users to intuitively recognize the alternative routes and make selection decisions more easily.

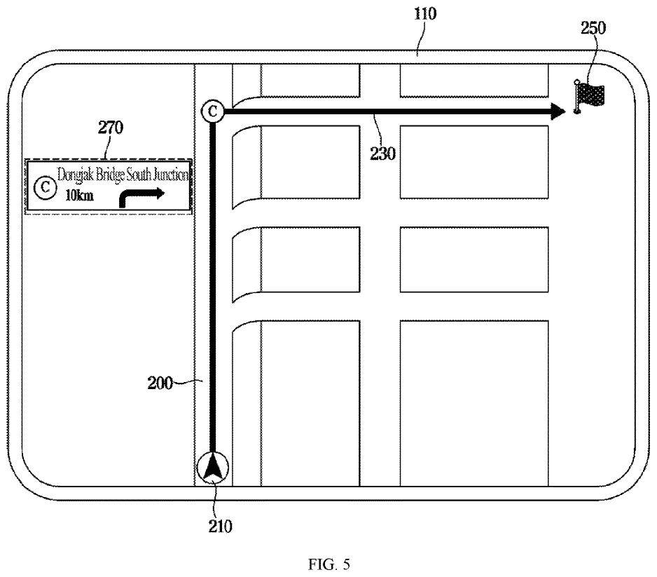

FIG. 5 illustrates a scenario where the navigation device 100 replaces the route 230 with an alternative route based on user input according to an embodiment.

Referring to FIG. 5, the navigation device 100 can replace the existing route with the selected alternative route when a user selects one from at least one alternative route.

For example, if a user selects the alternative route that includes the Banpo Bridge South Junction (C) as the route, the navigation device 100 can replace the route to the destination 250 with the alternative route including Banpo Bridge South Junction (C) and display it.

This allows the navigation device 100 to guide to the destination 250 using the alternative route based on user selection, and users can travel to the destination 250 via the alternative route.

It should be noted that the description has simplified the presentation by assuming that there are three junctions on the driving road 200, but the present invention is not limited to this, and the number of junctions that the navigation device 100 can guide is not restricted. In other words, the navigation device 100 can determine one or more alternative junctions other than the junction selected by the user and guide alternative routes for each determined junction.

Subsequently, examples of the control method for the navigation device 100 according to one aspect will be discussed. The control method for the navigation device 100 can use the same navigation device 100 as described in the previous examples. Therefore, the descriptions provided in FIGS. 1 to 5 can also be applied identically to the control method for the navigation device 100.

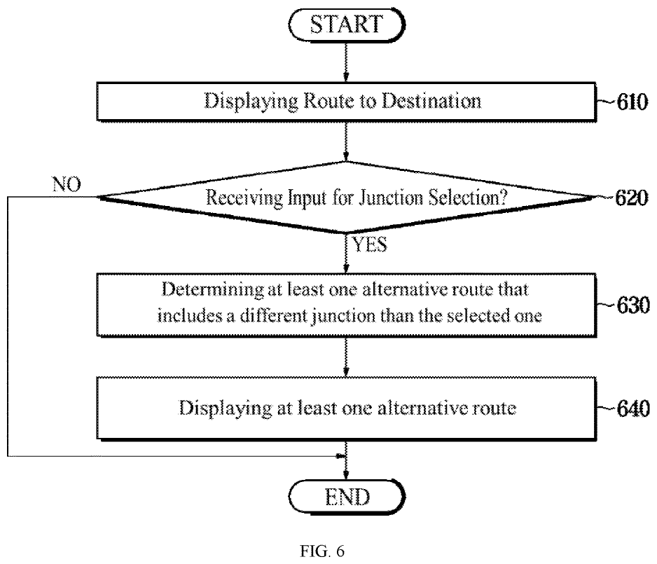

FIG. 6 is a flowchart illustrating a process of determining an alternative route that includes junctions other than the one selected by the user according to an embodiment of the navigation device 100.

Referring to FIG. 6, the navigation device 100 can display the route 230 to the destination 250 (610).

When the navigation device 100 receives input for junction selection (example at 620), it can determine at least one alternative route that includes a different junction than the selected one (630), and it can display at least one alternative route (640).

Specifically, if a user selects junction B on the route 230 to the destination 250, the navigation device 100 can determine at least one alternative route that includes different junctions (A, C) from the selected junction B among multiple junctions (A, B, C) on the driving road 200, and can control the user interface 110 to display at least one alternative route.

In this scenario, at least one alternative route may include a first alternative route that uses junction A located before the selected junction B on the driving road 200, and a second alternative route that uses junction C located after the selected junction B.

At this time, the navigation device 100 can control the user interface 110 to display comparison information for each alternative route with the existing route 230. The comparison information may include at least one of the following: information on the increase or decrease in distance, time, or cost compared to the existing route 230.

This allows users, who do not wish to follow the junction guided by the navigation device 100, to see the potential increases or decreases in distance, time, or cost when using different junctions, enabling them to choose the alternative route that best suits their needs. Thus, the navigation device 100, by providing information on routes associated with various junctions (A, B, C) located on the driving road 200, can expand users' range of route choices.

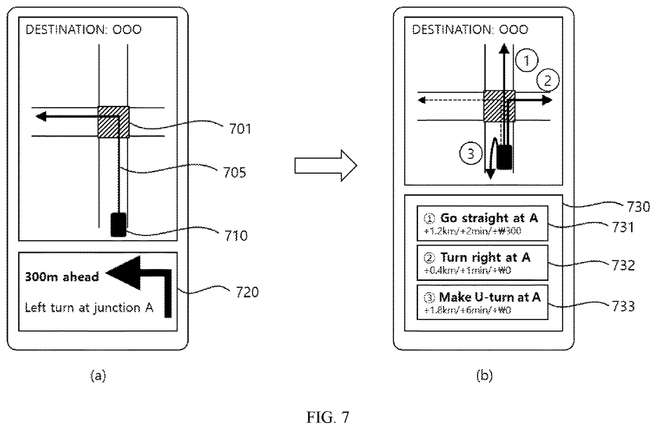

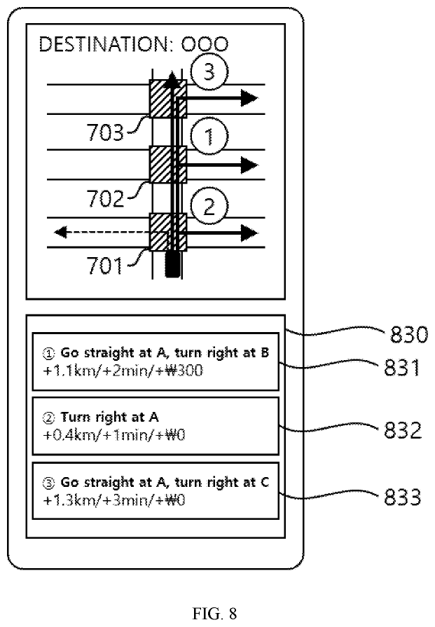

FIG. 7 is a diagram illustrating a case in which a navigation device according to an embodiment determines and displays at least one alternative action different from a guided driving action at the same junction as a guided junction, in response to an avoidance trigger input of a user, and FIG. 8 is a diagram illustrating a case in which a navigation device according to an embodiment determines and displays at least one alternative action.

Referring to FIG. 7, in this specification, the term “driving action” may also be referred to as a “driving maneuver,” and refers to an action or maneuver performed by a vehicle 710 at a junction or a specific point on a road, and may include, for example, at least one of a left turn, a right turn, going straight, a U-turn, exiting, entering, changing lanes, or merging. That is, the driving action in this specification is not limited to which branch road the vehicle 710 selects at a junction, and encompasses various maneuvers that the vehicle 710 can perform at the same junction or at the same point on the same road. In addition, in this specification, the term “junction” refers to a point at which two or more roads meet, a point at which lane changing is possible, or any point at which the vehicle 710 may perform one of a plurality of driving actions or maneuvers, and is not limited to an intersection or a branch lane separation point in a narrow sense.

Referring to FIG. 7(a), the control unit 130 according to an embodiment may control the user interface 110 to display a route 705 to a destination 250 entered by a user through the user interface 110, and may control the user interface 110 to display a guided action indication 720 indicating a driving action to be performed by the vehicle 710 at a junction to be guided from among junctions on the route 705, for example, junction A 701.

At this time, the guided action indication 720 may include, as an example, text information indicating a left turn at junction A 300 m ahead and visual icon information indicating the left turn, as shown in FIG. 7(a). However, the display form of the guided action indication 720 is not limited thereto, and the guided action indication 720 may be displayed in any form by which the user can recognize, visually, audibly, or haptically, an action to be guided at the junction.

The control unit 130 according to an embodiment may receive an avoidance trigger input from the user while the guided action indication 720 is displayed. The avoidance trigger input corresponds to an input indicating an intention of the user to avoid the guided action indicated by the guided action indication 720. An action of the user selecting a junction on a route to a destination may also correspond to the avoidance trigger input. When the navigation device receives the avoidance trigger input, the navigation device may display at least one route other than the proposed route 705 among various routes to the destination 250. That is, when the navigation device receives the avoidance trigger input from the user, the navigation device may determine at least one alternative route including at least one alternative action (or maneuver) different from a guided action corresponding to the avoidance trigger input on a road traveled by the vehicle, and may display the at least one alternative route.

The avoidance trigger input may be provided in various forms. More specifically, the avoidance trigger input may include at least one of a touch input on the guided action indication 720, a natural language command by the user's voice, or a predefined trigger input, and each of these will be described in more detail below.

In an embodiment, the avoidance trigger input may be performed by a touch input on the guided action indication 720. The user interface 110 according to an embodiment may receive a touch input of the user on an area in which the guided action indication 720 is displayed. At this time, the touch input on the guided action indication 720 may include at least one of one tap, two or more consecutive taps, for example, a double tap, a long press for a preset time or more, a swipe in a preset direction, or a pressure input of a preset pressure or more. In addition, the touch input on the guided action indication 720 may be an input on any one of specific areas within the guided action indication 720, for example, an icon area indicating the guided action, a text area in which a name of the guided action is displayed, or an area in which distance information of the guided action is displayed. Through this, the user can intuitively express an avoidance intention for the guided action by directly manipulating the guided action indication 720 without entering a separate menu.

In an embodiment, the avoidance trigger input may be performed by a natural language command by the user's voice. The user interface 110 according to an embodiment may receive a voice signal of the user through a voice input module, for example, a microphone, provided inside or outside the vehicle 710, and the control unit 130 according to an embodiment may extract text from the received voice signal and identify the avoidance intention of the user from the extracted text. That is, the control unit 130 according to an embodiment may process the avoidance trigger input in the form of a natural language command by performing a voice recognition step of extracting text from the voice signal of the user, an intent analysis step of determining whether an avoidance intention exists from the extracted text, and an avoidance target identification step of identifying an avoidance target when the avoidance intention exists.

At this time, the avoidance target may include at least one of a type of an action (or maneuver) to be avoided, for example, a left turn, a right turn, going straight, or a U-turn, an identifier of a junction to be avoided, for example, a name or location of the junction, an identifier of a road to be avoided, for example, a road name or bridge name, or an indicator referring to a guided action to be avoided, for example, that guidance or just that road. For example, when the user inputs a voice command saying “not that left turn,” the control unit 130 according to an embodiment may extract the type of the driving action to be avoided, namely left turn, from the voice command. In addition, when the user inputs a voice command saying “Banpo Bridge is congested” or “not Banpo Bridge,” the control unit 130 according to an embodiment may extract an identifier of the road or junction, namely Banpo Bridge, from the voice command. In addition, when the user inputs a voice command in the form of an indicator, such as “not there, another road” or “I do not like that road,” the control unit 130 according to an embodiment may identify, as the avoidance target, the action most recently guided based on the utterance time of the user, for example, the action indicated by the guided action indication 720.

In addition, the control unit 130 according to an embodiment may further identify, from the voice signal of the user, an avoidance reason clue in addition to the avoidance target. The avoidance reason clue is information indicating a reason or a preference condition for which the user intends to avoid the guided action, and may include, for example, a clue related to congestion, for example, “congested” or “there is congestion,” a clue related to driving difficulty, for example, “difficult” or “complicated,” a clue related to a burden of changing lanes, for example, “I do not like changing lanes,” a clue related to safety, for example, “dangerous,” or an alternative action explicitly instructed by the user, for example, going straight in “not right turn, I want to go straight.”

In an embodiment, the avoidance trigger input may be performed by a predefined trigger input. The predefined trigger input corresponds to an input in a form by which the user can express an avoidance intention through a simple input pattern defined in advance, even without directly manipulating the guided action indication 720 or uttering a natural language command. The control unit 130 according to an embodiment may determine whether the avoidance trigger input is received by comparing a predefined trigger pattern with a pattern of an input signal.

As specific examples of the predefined trigger input, at least one of a preset number of clap inputs, for example, two clap inputs, an input on a physical button or a touch button provided on a steering wheel, a dashboard, or a separate control panel of the vehicle 710, a hand gesture or a projection surface touch on an area corresponding to the guided action indication 720 displayed on a HUD, namely a head-up display, a gesture of a hand or head of the user recognized through a camera provided in the vehicle 710, for example, a hand-waving gesture or an action of shaking the head left and right, or a preset input pattern on a pedal or a transmission of the vehicle 710 may be provided as the predefined trigger input.

In addition, the predefined trigger pattern may be stored in advance as a default value in the navigation device 100, or may be a user-defined pattern directly defined or modified by the user through the user interface 110. That is, the control unit 130 according to an embodiment may receive, from the user, a setting input for at least one of a type, a number of times, a direction, or a recognition area of the predefined trigger input, and may update the predefined trigger pattern based on the received setting input.

As described above, the avoidance trigger input may be provided in a single form of any one of the touch input on the guided action indication 720, the natural language command by the user's voice, or the predefined trigger input, or may be provided in a combination form of two or more thereof. However, the form of the avoidance trigger input is not limited to the above examples, and may be provided in any form of input capable of indicating an intention of the user not to follow the guided action.

Referring to FIG. 7(b), when the control unit 130 according to an embodiment receives the avoidance trigger input, the control unit 130 may determine, at a junction corresponding to the avoidance trigger input, that is, junction A 701 at which the action indicated by the guided action indication 720 is to be performed, at least one alternative action different from the action indicated by the guided action indication 720.

As such, the control unit 130 according to an embodiment may determine, at the same junction A 701 among a plurality of junctions on the road 200 traveled by the vehicle 710, an alternative action different from the guided action. In other words, the control unit 130 according to an embodiment may identify, through the avoidance trigger input, that the user does not intend to avoid the junction itself but to avoid a specific guided action at the junction, and may determine another action possible at the same junction as an alternative and present the alternative to the user.

For example, as shown in FIG. 7(b), when the guided action at junction A 701 is a left turn, the control unit 130 according to an embodiment may determine at least one of going straight 731, a right turn 732, or a U-turn 733, which can be performed by the vehicle 710 at the same junction A 701, as an alternative action. That is, the alternative route may pass through junction A 701 but proceed along a route different from the route 705, or may proceed along a route bypassing junction A 701 itself. However, the type of the alternative action is not limited to a left turn, a right turn, going straight, or a U-turn, and may include any action that the vehicle 710 can perform physically or under road regulations at the corresponding junction A 701. For example, when junction A 701 is a lane change point, the alternative action may include changing lanes or maintaining a lane. In addition, when junction A 701 is an exit junction of an expressway, the alternative action may include exiting or going straight on the main road.

At this time, the control unit 130 according to an embodiment may derive a set of actions possible at junction A 701. First, the control unit 130 according to an embodiment may extract, from map information stored in the storage unit 140, at least one of a type of a road connected to junction A 701, the number of lanes, traveling direction information, and road regulation information, for example, one-way traffic, turn prohibition, or U-turn prohibition. Next, the control unit 130 according to an embodiment may derive a set of actions that can be performed by the vehicle 710 at junction A 701 based on the extracted information. Finally, the control unit 130 according to an embodiment may determine a set of alternative action candidates by excluding, from the derived set of actions, the action indicated by the guided action indication 720.

The control unit 130 according to an embodiment may determine at least one action among the determined set of alternative action candidates as an alternative action. At this time, the control unit 130 according to an embodiment may determine all actions included in the set of alternative action candidates as alternative actions, or may determine only some actions satisfying a preset criterion as alternative actions. The preset criterion may include, for example, at least one of an action in which an increased or decreased distance compared to the existing route 705 is equal to or less than a preset threshold value, an action in which an increased or decreased time compared to the existing route 705 is equal to or less than a preset threshold value, an action in which a likelihood that the user will prefer the action based on a past avoidance history of the user is equal to or greater than a threshold value, or an action selected a preset number of times or more based on a selection history of other users.

In addition, when an avoidance reason clue is extracted from the avoidance trigger input, the control unit 130 according to an embodiment may use the extracted avoidance reason clue to filter some of the set of alternative action candidates or determine a display priority of the alternative actions.

More specifically, when the avoidance reason clue includes an explicit instruction of an alternative action, for example, going straight in “not right turn, I want to go straight,” the control unit 130 according to an embodiment may control the user interface 110 to display the explicitly instructed action as the top item of the alternative action list 730.

In addition, when the avoidance reason clue includes a reason for avoidance or a preference condition, for example, a burden of changing lanes, congestion, driving difficulty, or safety, the control unit 130 according to an embodiment may sort the alternative action list 730 such that an action corresponding to the extracted reason or preference condition is located higher than an action not corresponding thereto, or may exclude an action not corresponding thereto from the set of alternative action candidates. For example, when the avoidance reason clue is “changing lanes is burdensome,” the control unit 130 according to an embodiment may determine the alternative action list 730 by placing, among the set of alternative action candidates, an action accompanied by lane changing lower than an action not accompanied by lane changing, or by excluding the action accompanied by lane changing from the set of alternative action candidates. Likewise, when the avoidance reason clue is a clue related to congestion, such as “congested,” the control unit 130 according to an embodiment may sort the alternative action list 730 with reference to real-time traffic information received from an external server, such that an action guiding the vehicle 710 to a road on which congestion does not occur among the set of alternative action candidates is located higher than an action guiding the vehicle 710 to a road on which congestion occurs.

In addition, the control unit 130 according to an embodiment may control the user interface 110 to display the alternative action list 730 including the determined at least one alternative action. As shown in FIG. 7(b), the alternative action list 730 may include going straight 731, a right turn 732, and a U-turn 733 at junction A 701 as separate items, respectively.

The control unit 130 according to an embodiment may control the user interface 110 to display comparison information with the existing route 705 for each alternative action 731, 732, 733 included in the alternative action list 730. The comparison information may include at least one of information on the increase or decrease in distance compared to the existing route 705 when each alternative action is followed, information on the increase or decrease in time compared to the existing route 705, or information on the increase or decrease in cost compared to the existing route 705.

For example, as shown in FIG. 7(b), each item of the alternative action list 730 may be displayed including comparison information such as +1.2 km/+2 minutes/+\300, +0.4 km/+1 minute/+\0, or +1.8 km/+6 minutes/+\0. However, the display format of the comparison information is not limited thereto, and may include any numerical information comparable with the existing route 705.

In addition, as shown in FIG. 7(b), the control unit 130 according to an embodiment may control the user interface 110 such that the user can visually compare the avoided action and the alternative action by displaying, together, a route of the avoided action, for example, a left turn at junction A 701, in the form of a dotted visual indication on a map area.

In another embodiment, referring to FIG. 8, when the user inputs an intention to avoid the guided driving action, the control unit according to an embodiment may determine an alternative route including a driving action to be performed at one or more other junctions located later based on the current traveling direction of the vehicle (e.g., junctions located downstream in the current traveling direction of the vehicle). For example, the control unit may determine a first alternative route in which the vehicle goes straight at junction A 701 and then turns right at junction B 702, a second alternative route in which the vehicle turns right at junction A 701, and a third alternative route in which the vehicle goes straight at junction A 701 and then turns right at junction C 703, and may display each alternative route in correspondence with the map area.

The control unit may control the user interface to display an alternative route list 830 including the determined plurality of alternative routes. The alternative route list 830 may include a first item 831 corresponding to the first alternative route, a second item 832 corresponding to the second alternative route, and a third item 833 corresponding to the third alternative route. The control unit may display, in the alternative route list 830, at least one of information on the increase or decrease in distance, time, or cost compared to the existing route together with driving actions for respective junctions included in the corresponding alternative route. Accordingly, the user can compare and select not only a method of immediately selecting another action at the same junction, but also which action is to be performed at which subsequent junction after avoiding the currently guided action. According to embodiments, the control unit may suggest a route going straight at all of junctions A, B, and C 701 to 703, or may suggest a route turning left at any junction, and the embodiment is not necessarily limited to what is illustrated.

Through this, before entering the junction, the user can intuitively check which alternative action can be selected at the same junction after avoiding the guided action, and can select an alternative action suitable for the user's preference or driving situation.

Referring again to FIG. 7, when the control unit 130 according to an embodiment receives, from the user, a selection of any one alternative action, for example, going straight 731, from the alternative action list 730, the control unit 130 may control the user interface 110 to generate and display an updated route by maintaining the existing route 705 in a section before junction A 701, following the selected alternative action at junction A 701, and determining a new route to the destination 250 with an expected position of the vehicle 710 after performing the selected alternative action at junction A 701 as a starting point.

Meanwhile, when the control unit 130 according to an embodiment receives the avoidance trigger input, in addition to presenting the same-junction alternative action at junction A 701, the control unit 130 may control the user interface 110 to also present an alternative route passing through another junction other than junction A 701, as described with reference to FIGS. 3 to 5. In this case, the alternative action list 730 may include both alternative actions at the same junction A 701, for example, going straight 731, a right turn 732, or a U-turn 733, and an alternative route passing through another junction other than junction A 701, for example, a junction located before junction A 701 or a junction located after junction A 701. Through this, the user can integrally check, by only one input expressing the avoidance intention, another action option at the same junction and an alternative route option passing through another junction.

In the above, a case in which the guided action at junction A 701 is a left turn has been described as an example, but the present invention is not limited thereto, and may be equally applied even when the guided action is any action such as a right turn, going straight, a U-turn, changing lanes, exiting, entering, or merging.

In addition, in the above, description has been made on the premise that the user interface 110 includes a display panel, but the present invention is not limited thereto, and the user interface 110 may also be implemented in a form including an auditory output device by voice synthesis, a haptic output device, a HUD, namely a head-up display device, an AR, namely augmented reality, display device, or a cluster of the vehicle 710. In this case, the guided action indication 720, the alternative action list 730, and the comparison information may be output through at least one of the above output devices.

In the above, an embodiment in which an alternative action at the same junction is immediately provided in response to an avoidance trigger input has been described. However, embodiments of the present invention are not limited to such an immediate response-type interaction, and the navigation device 100 according to an embodiment may be implemented not only to process the avoidance trigger input as a single input of the user, but also to infer and store an intention or preference condition of the user implied in the avoidance trigger input and reflect the same in subsequent route guidance.

More specifically, when the control unit 130 according to an embodiment receives the avoidance trigger input, the control unit 130 may collect context information at a time point at which the avoidance trigger input occurs, for example, a time zone, a day of the week, weather, a real-time traffic situation, a departure point, a destination, an avoided junction, and a type of an avoided action, and may infer an avoidance reason of the user based on the collected context information and an avoidance reason clue extracted from the avoidance trigger input. The inferred avoidance reason may correspond to, for example, any one of avoidance of congestion on a road connected to the corresponding junction, avoidance of an action having high driving difficulty, avoidance of a burden of changing lanes, lack of trust in a guided action at a specific time zone, or avoidance of a specific road or bridge that the user has empirically avoided.

For example, when the user avoids guidance for entering Banpo Bridge, this may be applied later when a route for entering Banpo Bridge is provided. In addition, this may be applied later at a similar time zone, in a similar traffic situation, or when guidance to a similar destination is provided, namely when a route corresponding to the inferred reason is presented. When the navigation device 100 provides the route for entering Banpo Bridge again, the navigation device 100 may automatically provide an avoidance route together with the route, even when the user does not perform an explicit avoidance action.

In addition, when the navigation device 100 infers the avoidance action of the user and provides guidance for a route corresponding to the same avoidance reason, the navigation device 100 may automatically provide an avoidance route together at the corresponding point.

In addition, the control unit 130 according to an embodiment may store the inferred avoidance reason and context information in the storage unit 140 as preference information of the user, and in this case, even when the avoidance trigger input of the user occurs only once for the same junction or the same action, the control unit 130 may be implemented to store the same as preference information of the user. That is, the control unit 130 according to an embodiment is not limited to learning repeated avoidance actions, and may interpret and store even a single avoidance action as an intention or preference signal of the user.

For example, when the user avoids guidance for entering Banpo Bridge, refuses to enter a specific interchange, or modifies a specific lane-changing maneuver, the navigation device 100 may understand this as a route selection tendency or intention of the user and may reflect the same later in the same or a similar situation.

In addition, the control unit 130 according to an embodiment may automatically provide an avoidance route together during subsequent route guidance based on the stored preference information of the user, even when the user does not input an explicit avoidance trigger input. More specifically, when the vehicle 710 is about to enter again a junction that the user has avoided in the past, or to perform again an action that the user has avoided in the past, or when the control unit 130 is about to present again a guided action corresponding to the avoided action in a context identical or similar to the inferred avoidance reason, for example, the same time zone, a similar traffic situation, or the same destination, the control unit 130 according to an embodiment may control the user interface 110 to display an avoidance route or an alternative action together even without an explicit input of the user. The provision of such an automatic avoidance route may be applied not only at a time point of re-guidance of the same route, but also at a time point of guidance of a different route through the identity of the avoidance reason.

In addition, when the user selects and performs an alternative action or an alternative route without following the guided action, the control unit 130 according to an embodiment may compare at least one of an actual driving result according to the alternative route selected by the user, for example, an actual required time or an actual degree of congestion, and a predicted result when the guided action had been followed, for example, a predicted time at the guidance time point or an average required time derived from actual driving data of other vehicles that traveled the same guided route at the same time zone, and may provide the comparison result to the user as evaluation feedback. At this time, a time point at which the evaluation feedback is provided may be a driving end time point at which the vehicle 710 arrives at the destination 250, or may be a merging time point at which the alternative route selected by the user and the guided route merge again, for example, a time point of entering an intersection at which the two routes meet again at the same point.

For example, the navigation device 100 may provide the user with evaluation results such as “the route selected by the user was actually 3 minutes faster,” “average congestion was lower compared to the existing recommended route,” or “the user's judgment was more consistent with the actual traffic situation,” at the driving end time point or at a time point at which the alternative route and the existing route coincide, that is, when, in a route to Gangnam Station via Olympic-daero, the user avoids the Dongjak Bridge junction and selects the Banpo Bridge junction, at a time point of entering the intersection in front of Catholic University where the two routes merge. That is, the control unit 130 may obtain at least one of a first history of another vehicle that selected the initial route without selecting the alternative route or an expected history upon proposal of the initial route, and may obtain a second history of a vehicle that selected the alternative route. The control unit 130 may display, through the user interface, a difference between at least one of the first history or the expected history and the second history, and may reflect the difference in a subsequent route recommendation. The history may include a time required until driving to a specific point is completed. The specific point may indicate the destination or may indicate a point at which the initial route and the alternative route merge.

In addition, the control unit 130 according to an embodiment may update a personalized route guidance model specific to the corresponding user based on the result of the above evaluation feedback and accumulated data of the avoidance actions of the user, or may update a route guidance model for all users based on avoidance data of a plurality of users on an external server by transmitting avoidance action and evaluation result data to the external server through the communication unit 120. As an example, when a plurality of users repeatedly input avoidance actions for the same guided action, the route guidance model on the external server may be updated in a form of increasing a routing weight of a road section corresponding to the guided action or lowering a recommendation priority for the guided action.

Provision of alternative routes in existing navigation software generally relates to comparison or re-searching in units of an entire route for reaching a destination, and may operate in a manner of presenting another entire route based on distance, time, tolls, or traffic situations when the user selects a specific route or deviates from a current route. In contrast, action avoidance in the present invention is not a concept of simply replacing the entire route to the destination with another route, but is a concept of identifying, as an avoidance target, the driving action itself that the user is guided to perform at a specific junction or a specific road point currently being guided. For example, when the user provides an input such as “not left turn,” “I do not like that road,” or “I do not like changing lanes,” the navigation device may identify an intention to avoid a guided action, such as a left turn at a specific junction, a specific entering action, or a specific lane-changing action, rather than processing the input as the user rejecting the destination itself or the entire route. Therefore, the avoidance target in the present invention may not be the entire route, but may be an individual driving maneuver (or driving action) constituting the route, and the alternative route may be generated or displayed as a result of determining an alternative action that replaces the avoided driving action.

In addition, unlike an existing route search method, the provision of an alternative route based on action avoidance according to the present invention does not process the avoidance intention of the user as a simple request for route re-searching, but may first derive another driving action that can be performed at the same junction or in the same driving situation, and then update the route to the destination based on an expected position of the vehicle after the selected alternative action. Accordingly, the user can intuitively input an intention of “wanting to avoid only this action” based on the currently guided action, without entering a separate route setting menu or entering the destination again, and the navigation device can reconstruct only the route after the avoidance target action while maintaining a section before the avoidance target in the existing route. As a result, an operation burden during driving is reduced, avoidance in units of actions that actually cause inconvenience to the user becomes possible, and when an avoidance reason or an avoidance history is stored, an avoidance route or an alternative action can be provided together later without an explicit input of the user at the same or a similar junction, road, time zone, or traffic situation. Therefore, unlike existing provision of alternative routes that simply lists other routes, the present invention can be differentiated in that the present invention can reflect, in route guidance, a momentary driving intention of the user and a preference in units of actions.

Detailed explanation have been provided on the navigation device and its control method according to an embodiment of the present invention, as illustrated in the accompanying drawings.

According to an embodiment of the present invention regarding the navigation alternative route display method and device, it is possible to provide multiple alternative routes that use different junctions than the one selected by user input. This allows users to choose alternative routes that better suit their preferences, thereby enhancing the utility of the navigation device.

Meanwhile, the disclosed embodiments are described in terms of devices that store computer-executable instructions, which can be implemented as hardware components, software components, or a combination of hardware and software components. For instance, the devices and components described in the embodiments can be implemented using one or more general-purpose computers or special-purpose computers, such as processors, controllers, ALUs (arithmetic logic units), digital signal processors, microcomputers, FPAs (field-programmable arrays), PLUS (programmable logic units), microprocessors, or any other devices capable of executing and responding to instructions. The processing device can perform one or more software applications running on an operating system (OS) and can also access, store, manipulate, process, and generate data in response to the execution of software. For convenience of understanding, it is described that one processing device is used, but those skilled in the relevant field will understand that the processing device can include multiple processing elements and/or multiple types of processing elements. For example, the processing device may include multiple processors or one processor and one controller. Other processing configurations, such as parallel processors, are also possible.

Software may include a computer program, code, instruction, or a combination thereof, which may configure the processing device to operate as desired or command the processing device independently or collectively. Software and/or data can be embodied in any type of machine, component, physical device, virtual equipment, computer storage medium, or device to provide instructions or data to the processing device. Software and data can be distributed across a computer system connected via a network, stored or executed in a distributed manner. Software and data can be stored on one or more computer-readable recording media.

As such, although the embodiments have been described through limited examples and drawings, various modifications and variations can be made by those skilled in the art based on the descriptions herein. For example, the described technologies can be performed in a different order from the described methods, and/or the described systems, structures, devices, circuits, and other components can be combined or arranged in different forms from the described methods, or replaced or substituted by other components or equivalents. Therefore, other implementations, other embodiments, and equivalents to the claims are within the scope of the following claims.

What is claimed is:

1. A navigation device comprising:
a user interface receiving an input from a user and displaying a route; and
a control unit configured to control the user interface to display a route to a destination entered by the user as an existing route, and, when receiving, from the user, an avoidance trigger input indicating an intention to avoid a guided action on a road traveled by a vehicle, determine at least one alternative route including at least one alternative action different from the guided action, and control the user interface to display the at least one alternative route.

2. The navigation device of claim 1, wherein the control unit controls the user interface to display comparison information between each alternative route among the at least one alternative route and the existing route.

3. The navigation device of claim 2, wherein the comparison information comprises at least one of information on the increase or decrease in distance compared to the existing route, information on the increase or decrease in time compared to the existing route, and information on the increase or decrease in cost compared to the existing route.

4. The navigation device of claim 1, wherein the avoidance trigger input comprises at least one of an input through the user interface, a voice-based input, and a predefined trigger input,
wherein the control unit determines the at least one alternative route based on a past avoidance history of the user when the avoidance trigger input is received, and
wherein, for an alternative route among the at least one alternative route, the control unit obtains at least one of a first history of another vehicle that selected the existing route without selecting the alternative route or an expected history at a time when the existing route is proposed, obtains a second history of a vehicle that selected the alternative route, displays a difference between the second history and at least one of the first history or the expected history through the user interface, and reflects the difference in a subsequent route recommendation.

5. The navigation device of claim 1, wherein the control unit controls the user interface to display an alternative route selected by the user when the user selects one alternative route from among the at least one alternative route.

6. The navigation device of claim 1, wherein the control unit replaces the existing route with an alternative route selected by the user when the user selects one alternative route from among the at least one alternative route.

7. A method of controlling a navigation device comprising a user interface, the method comprising:
controlling the user interface to display a route to a destination entered by a user as an existing route;
receiving, from the user, an avoidance trigger input corresponding to a guided action on a road traveled by a vehicle;
determining, in response to receiving the avoidance trigger input, at least one alternative route including at least one alternative action different from the guided action; and
controlling the user interface to display the at least one alternative route.
